(19) United States
(12) Patent Application Publication
(10) Pub. No.: US 2009/0233169 A1
(43) Pub. Date: Sep. 17, 2009

(54) BATTERY MODULE AND BATTERY PACK

(76) Inventors: Takeo KAKUCHI, Chofu-shi (JP); Taihei KOYAMA, Tachikawa-shi (JP); Yosuke TONAMI, Asaka-shi (JP); Takafumi NAKAHAMA, Fuchu-shi (JP); Norihito TOGASHI, Yokohama-shi (JP); Kenji SATO, Hachioji-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/404,525

(22) Filed: Mar. 16, 2009

(30) Foreign Application Priority Data
Mar. 17, 2008 (JP) 2008-068303

(51) Int. Cl. H01M 2/08; H01M 2/02

(52) U.S. Cl. 429/185; 429/163

(57) ABSTRACT

A battery module provided with a cell which contains an electrode group and a non-aqueous electrolyte and a case including a cell containing portion which contains the cell and a hollow portion which communicates with the cell containing portion and configured so that an outlet is formed in each of a pair of sidewalls thereof which face each other with the hollow portion therebetween.

### CROSS-REFERENCE TO RELATED APPLICATIONS

This application is based upon and claims the benefit of priority from prior Japanese Patent Application No. 2008-068303, filed Mar. 17, 2008, the entire contents of which are incorporated herein by reference.

### BACKGROUND OF THE INVENTION

1. Field of the Invention

This invention relates to a battery module and a battery pack, and more particularly, to a battery module that contains a secondary battery (cell) such as a lithium-ion battery, which uses a non-aqueous electrolyte, and a battery pack in which a plurality of battery modules are electrically connected to one another.

2. Description of the Related Art

In recent years, non-aqueous secondary batteries, especially lithium-ion batteries, have been noted as energy sources for driving vehicles, such as electric vehicles, as well as ones for cordless, portable electronic devices.

If the internal pressure of a cell is increased by overcharge or the like, in these non-aqueous secondary batteries, a non-aqueous electrolyte and its gas component may leak out when the cell ruptures. According to a technique disclosed in Japanese Patent No. 3014293 (Patent Document 1), for example, a housing of a battery pack is provided with a partition wall, which divides a battery chamber and an electric circuit chamber that contain the cell and an electric circuit, respectively. The partition wall serves to isolate the electric circuit from an atmosphere on the cell side. According to this Patent Document 1, moreover, a technique is also disclosed such that the cell side of the housing is bored with at least one safety hole through which the non-aqueous electrolyte or its vapor leaked from the cell is released.

### BRIEF SUMMARY OF THE INVENTION

The object of this invention is to provide a battery module and a battery pack configured to discharge an electrolyte and its gas component ejected from a cell to the outside.

A battery module according to an aspect of the invention comprises: a cell which contains an electrode group and a non-aqueous electrolyte; and a case including a cell containing portion which contains the cell and a hollow portion which communicates with the cell containing portion and configured so that an outlet is formed in each of a pair of sidewalls thereof which face each other with the hollow portion therebetween.

A battery pack according to another aspect of the invention comprises: a battery module including a cell which contains an electrode group and a non-aqueous electrolyte and a case including a cell containing portion which contains the cell and a hollow portion which communicates with the cell containing portion and configured so that an outlet is formed in each of a pair of sidewalls thereof which face each other with the hollow portion therebetween; and a tubular body fitted in the outlet formed in the case of the battery module, a plurality of the battery modules being connected to one another by the tubular body.

According to this invention, the case of which the cell containing portion contains the cell includes the hollow portion that communicates with the cell containing portion. Further, the outlet is formed in each of the pair of sidewalls of the case that face each other with the hollow portion therebetween. If the electrolyte and its gas component are ejected from the cell, therefore, they can be safely and securely discharged from the outlet to the outside of the battery module or the battery pack through the hollow portion.

Thus, corrosion or short-circuiting by the electrolyte and its gas component can be suppressed, and the reliability can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing a construction of a battery module according to one embodiment of the invention;

FIG. 2 is an enlarged perspective sectional view of a hollow portion of a case of the battery module shown in FIG. 1;

FIG. 3 is an enlarged sectional view of the hollow portion of the battery module shown in FIG. 1;

FIG. 4 is a perspective view schematically showing a construction of a battery module provided with a tubular body according to the one embodiment of the invention;

FIG. 5 is an enlarged sectional view of the respective hollow portions of the connected battery modules shown in FIG. 4;

FIG. 6 is a perspective view schematically showing a construction of a battery module provided with a tubular body of another construction according to the one embodiment of the invention;

FIG. 7 is an enlarged sectional view of the respective hollow portions of the connected battery modules shown in FIG. 6;

FIG. 8 is an enlarged sectional view of hollow portions of battery modules provided with a sealing member of another construction according to the one embodiment of the invention; and

FIG. 9 is an enlarged perspective sectional view of the hollow portions of the battery modules shown in FIG. 8.

### DETAILED DESCRIPTION OF THE INVENTION

A battery module and a battery pack according to one embodiment of this invention will now be described with reference to the accompanying drawings.

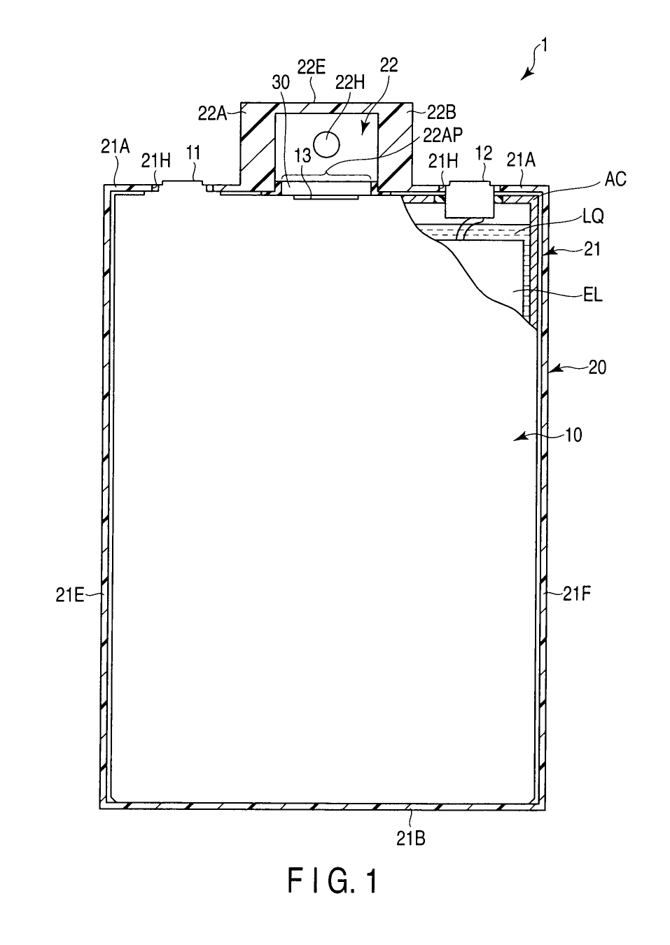

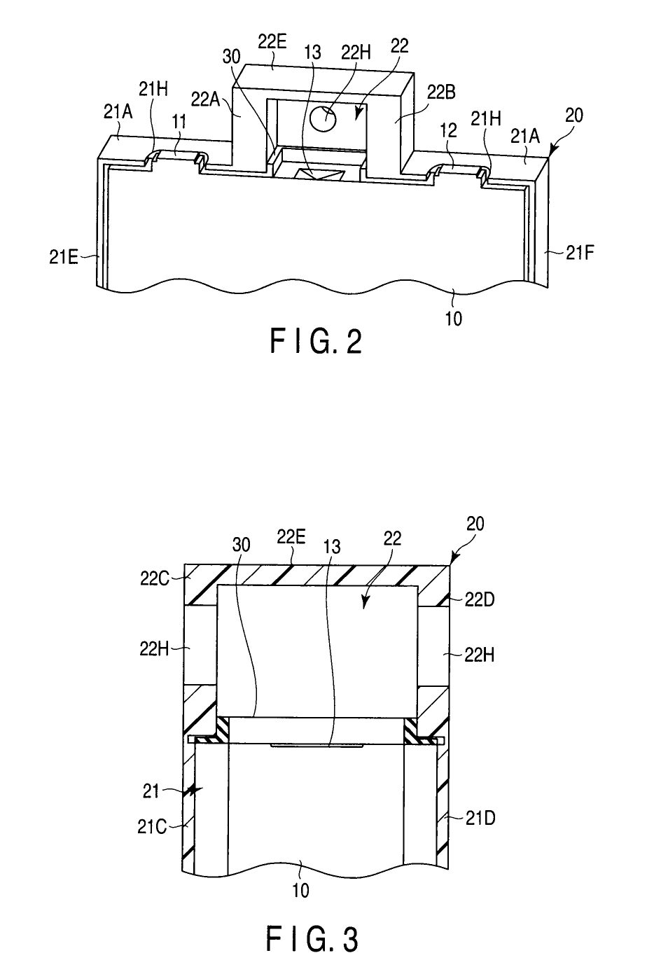

As shown in FIGS. 1 to 3, a battery module 1 is composed of a cell 10 and a case 20 that can contain the cell 10.

Specifically, the cell 10 is a secondary battery such as a lithium-ion battery, which uses a non-aqueous electrolyte LQ, and is designed so that an electrode group EL and the non-aqueous electrolyte LQ are hermetically sealed in an armor case AC. The external shape of the cell 10 (i.e., that of the armor case AC) is substantially rectangular parallelepipedic.

The electrode group EL includes a positive electrode and a negative electrode that are coiled with a separator between them and has a radially compressed, flat rectangular shape. A positive terminal 11 and a negative terminal 12 are connected to the positive and negative electrodes, respectively, of the electrode group EL. The positive and negative terminals 11 and 12 both protrude outward from one surface (upper surface) of the armor case AC.

Further, the cell 10 is provided with a rupture plate 13 on the upper surface of the armor case from which the positive and negative terminals 11 and 12 protrude. The rupture plate 13 is configured to rupture, thereby allowing the electrolyte or its gas component to escape from the cell 10, if the internal pressure of the cell increases.

The case 20 includes a cell containing portion 21 and a hollow portion 22 that communicate with each other. The case 20 is formed of a resin, such as polycarbonate (PC) or polyphenylene sulfide (PPS) resin, or ceramics.

The cell containing portion 21 is formed as a rectangular parallelepipedic space larger than the contour of the cell 10. The cell containing portion 21 is defined by six wall plates 21A to 21F that surround the cell 10. These six wall plates 21A to 21F may be formed integrally with one another, or alternatively, at least one wall plate may be joined to another one by screwing or some other method. The one wall plate 21A that defines the cell containing portion 21 faces the upper surface of the cell 10 and is formed with two insertion holes 21H into which the positive and negative terminals 11 and 12 of the cell 10 can be inserted.

When the cell 10 is contained in the cell containing portion 21, a small gap for the passage of a coolant (e.g., cold blast) is formed between the cell 10 and the case 20. Further, the positive and negative terminals 11 and 12 that are inserted individually into the insertion holes 21H project outward from the wall plate 21A, so that they can be easily connected to leads.

The hollow portion 22 is formed as a projection that protrudes outward (i.e., oppositely from the cell containing portion 21) from the wall plate 21A. The hollow portion 22 communicates with the cell containing portion 21 through a substantially rectangular opening 22AP formed in the wall plate 21A. In this embodiment, the hollow portion 22 is formed as a substantially rectangular parallelepipedic space, which is surrounded by four sidewalls 22A to 22D that rise outward from the wall plate 21A and a top wall 22E that faces the opening 22AP across the hollow portion 22. The hollow portion 22 is not limited to this illustrated shape but may be of another shape.

The sidewall 22A extends substantially at right angles to the wall plate 21A from which the positive terminal 11 projects and is formed, for example, integrally with the wall plate 21A. The sidewall 22B extends substantially at right angles to the wall plate 21A from which the negative terminal 12 projects and is formed, for example, integrally with the wall plate 21A.

The sidewall 22C is a flat plate that extends parallel to the wall plate 21C so as to be, for example, integral with the plate 21C. The sidewall 22D is a flat plate that extends parallel to the wall plate 21D so as to be, for example, integral with the plate 21D. The top wall 22E is substantially rectangular and formed, for example, integrally with the four sidewalls 22A to 22D.

The opening 22AP is formed so as to face the rupture plate 13 of the cell 10 in the cell containing portion 21. Thus, the hollow portion 22 faces the rupture plate 13 across the opening 22AP within the case 20.

Of the four sidewalls 22A to 22D, the pair of sidewalls 22C and 22D that are opposed to each other across the hollow portion 22 are formed with outlets 22H, individually. These outlets 22H penetrate the sidewalls 22C and 22D from the hollow portion 22 to the outside (so that the inside and outside of the case 20 communicate with each other). Each of the outlets 22H is cylindrical, for example.

According to the battery module 1 constructed in this manner, the hollow portion 22 faces the rupture plate 13 of the cell 10 that is contained in the cell containing portion 21. If the rupture plate 13 ruptures, thereby allowing the electrolyte in the cell and its gas component to be ejected, therefore, the electrolyte and the gas component are discharged into the hollow portion 22. The internal pressure of the cell 10 can be reduced especially when the gas component that causes its increase is discharged into the hollow portion 22.

Further, the outlets 22H that individually open to the outside are formed individually in the sidewalls 22C and 22D that define the hollow portion 22. Thus, the ejected electrolyte and gas component are discharged to the outside of the case 20, that is, the outside of the battery module 1, through the outlets 22H.

Accordingly, corrosion or short-circuiting of the cell 10 by the ejected electrolyte and gas component can be suppressed, and the reliability can be improved.

As shown in FIGS. 1 to 3, moreover, the battery module 1 is provided with a sealing member 30 for sealing the hollow portion 22 to the cell containing portion 21 within the case 20. The sealing member 30 is formed of rubber or some other material that is resistant to corrosion by the electrolyte and has elasticity and a sealing function. The sealing member 30 is in close contact with the cell 10 that is contained in the cell containing portion 21. Further, the sealing member 30 is formed in a ring shape that ensures communication between the rupture plate 13 and the hollow portion 22.

In the example described herein, the sealing member 30 has a substantially L-shaped cross section. Thus, the sealing member 30 is located so as to seal the gap between the cell 10 and the case 20 (between the cell 10 and the wall plate 21A, in particular) and is in close contact with the four sidewalls 22A to 22D that define the hollow portion 22.

The sealing member 30 constructed in this manner may be previously adhesively bonded to the cell 10. Further, the sealing member 30 may be previously fitted into the hollow portion 22 so that it can be deformed and brought into close contact with the cell 10 and the case 20 under a sufficient surface pressure when the cell 10 is contained in the cell containing portion 21.

According to the battery module 1 using this sealing member 30, the electrolyte and its gas component ejected from the cell 10 can be prevented from infiltrating into a space (within the cell containing portion 21) between the cell 10 and the case 20. Further, the electrolyte and its gas component can be prevented from being mixed into the coolant.

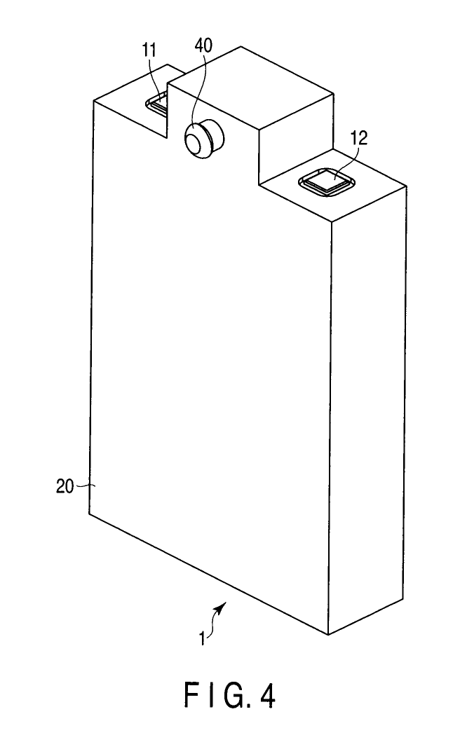

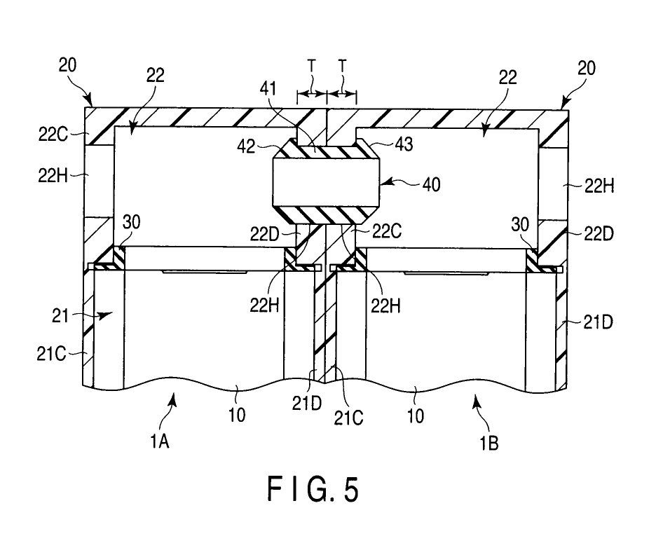

In an example shown in FIGS. 4 and 5, a battery module 1 is provided with a tubular body 40 that is fitted in at least one of the pair of outlets 22H in the case 20. The tubular body 40 is formed of rubber or some other material that is resistant to corrosion by the electrolyte and has elasticity and a sealing function.

In the example described above, the tubular body 40 includes a tube portion 41 and a pair of rings 42 and 43 that are formed integrally with the tube portion 41.

The tube portion 41 has an outside diameter equal to the inside diameter of each outlet 22H. Thus, the tube portion 41 is in close contact with the inner surface of each outlet 22H. Further, the tube portion 41 has a length greater than that of each outlet 22H, that is, a thickness T of each of the sidewalls 22C and 22D of case 20, or substantially twice as great as the thickness T of each sidewall. The rings 42 and 43 are connected individually to the opposite ends of the tube portion 41 and have an outside diameter greater than the inside diameter of the outlets 22H. When the tubular body 40 is fitted in each outlet 22H, the rings 42 and 43 are located in the hollow portion 22. This tubular body 40 may be adhesively bonded to each outlet 22H or need not be specially fixed to the case 20.

According to the battery module 1 using this tubular body 40, the electrolyte and its gas component discharged into the hollow portion 22 can be discharged from the module 1 through the tubular body 40.

Further, a plurality of battery modules 1 can be connected to one another by using the tubular body 40. In the case shown in FIG. 5, the tubular body 40 is fitted in the outlets 22H in the sidewalls of the respective cases 20 of two adjacent battery modules 1A and 1B.

Specifically, the ring 42 of the tubular body 40 is situated in the hollow portion 22 of the one battery module 1A and in close contact with the inner surface of the sidewall 22D. Further, the tube portion 41 is in close contact with the outlet 22H of the sidewall 22D.

The other battery module 1B is configured so that the sidewall 22D of its case 20 is opposed to and in close contact with the sidewall 22C of the battery module 1A. The ring 43 of the tubular body 40 is situated in the hollow portion 22 of this battery module 1B and in close contact with the inner surface of the sidewall 22C. Further, the tube portion 41 is in close contact with the outlet 22H of the sidewall 22C.

Since the length of the tube portion 41 is equal to the sum of the respective thicknesses of the sidewalls 22C and 22D, the two battery modules 1A and 1B can be connected to each other with the sidewalls 22C and 22D in close contact with each other. In this case, the tubular body 40 may be adhesively bonded to the two battery modules 1A and 1B.

If the rupture plate 13 in the one battery module 1A ruptures, according to this arrangement, the electrolyte and its gas component can be guided from the hollow portion 22 to that of the other battery module 1B that is connected to the battery module 1A by the tubular body 40. Thus, the capacity of a space that accommodates the ejected electrolyte and gas component can be increased, so that a buffer function to reduce the pressure can be improved. Even in the case of a battery pack that is composed of a plurality of battery modules connected to one another, moreover, the electrolyte and its gas component can be safely and securely discharged from the battery pack.

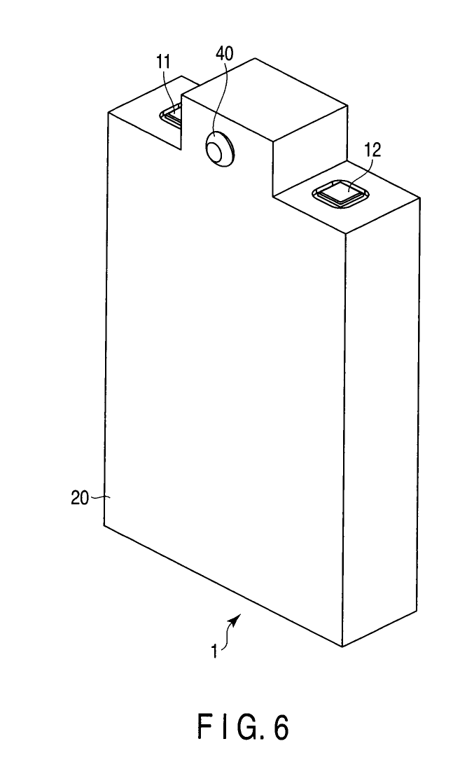

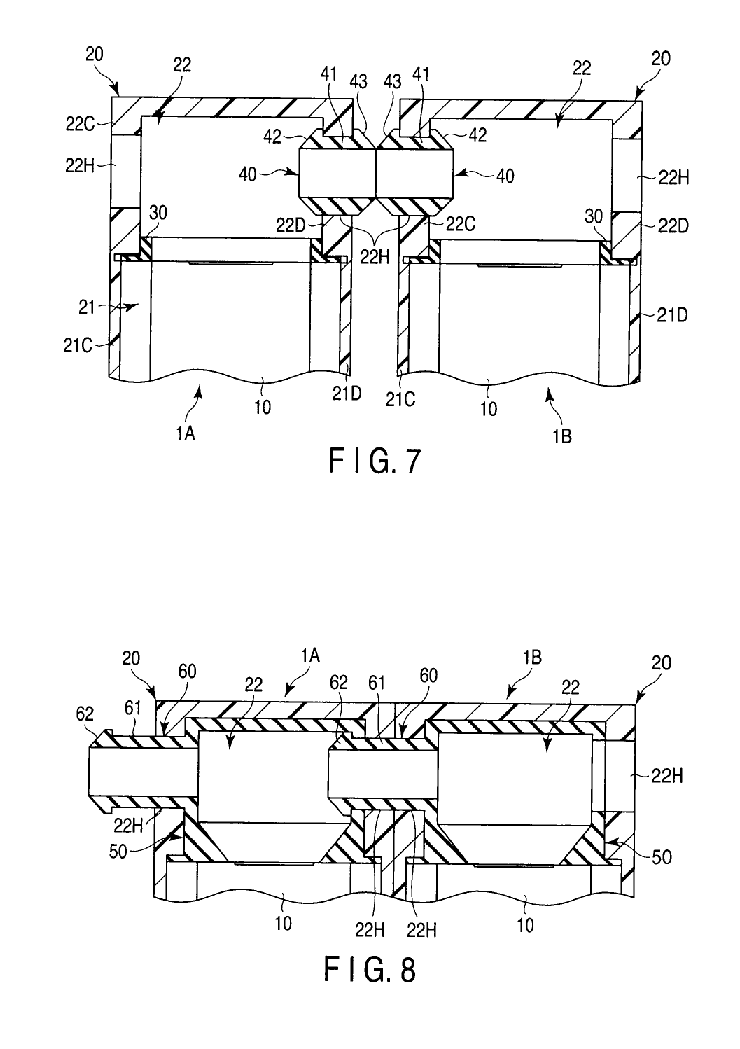

In a modification of the tubular body 40, as shown in FIGS. 6 and 7, for example, the tube portion 41 may be configured so that its length is equal to the thickness T of each sidewall. This tubular body 40 is fitted in the outlet 22H in such a manner that its rings 42 and 43 are in close contact with the inner and outer surfaces, respectively, of the sidewall. In this modification, the respective rings 43 of two tubular bodies 40 that are in close contact with the respective outer surfaces of the sidewalls of two battery modules are brought into close contact with each other, whereby the tube portions 41 communicate with each other.

If the rupture plate 13 in the one battery module 1A ruptures, according to this arrangement, the electrolyte and its gas component can be guided from the hollow portion 22 to that of the other battery module 1B through the two tubular bodies 40. Thus, the capacity of a space that accommodates the ejected electrolyte and gas component can be increased, as in the case shown in FIGS. 4 and 5. Even in the case of a battery pack that is provided with a plurality of battery modules, moreover, the electrolyte and its gas component can be safely and securely discharged from the battery pack.

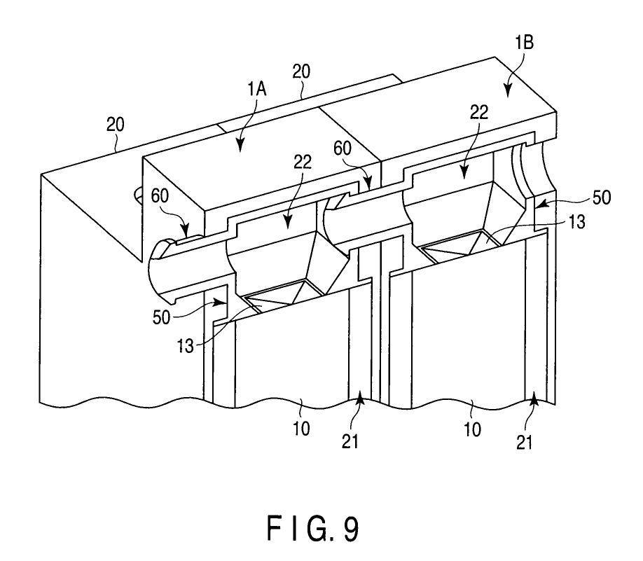

In an example shown in FIGS. 8 and 9, each battery module 1 is provided with a sealing member 50 for sealing the hollow portion 22 to the cell containing portion 21 within the case 20. Further, the sealing member 50 includes a tubular body 60 that extends outward from one of the pair of outlets 22H. The sealing member 50 is formed of rubber or some other material that is resistant to corrosion by the electrolyte and has elasticity and a sealing function.

The sealing member 50 is in close contact with the cell 10 that is contained in the cell containing portion 21. Further, the sealing member 50 is provided with an opening that faces the rupture plate 13 and ensures communication with the hollow portion 22. Thus, the sealing member 50 seals the hollow portion 22 to the cell containing portion 21. In this illustrated example, the sealing member 50 has an external shape that is congruous to the internal shape of the hollow portion 22 and is in close contact with all the sidewalls and the top wall that define the hollow portion 22.

The tubular body 60 is fitted in the outlet 22H that is formed in one of the sidewalls that define the hollow portion 22. Specifically, the tubular body 60 includes a tube portion 61 and a ring 62 that is formed integrally with the tube portion 61. The tube portion 61 has an outside diameter equal to the inside diameter of each outlet 22H. Thus, the tube portion 61 is in close contact with the inner surface of each outlet 22H. Further, the tube portion 61 is longer than each outlet 22H. The ring 62 is connected to one end of the tube portion 61 that projects form the sidewall and has an outside diameter greater than the inside diameter of each outlet 22H.

The sealing member 50 constructed in this manner may be previously adhesively bonded to the cell 10 or the case 20. Further, the sealing member 50 may be previously fitted into the hollow portion 22 so that it can be deformed and brought into close contact with the cell 10 and the case 20 under a sufficient surface pressure when the cell 10 is contained in the cell containing portion 21.

According to the battery module 1 using this sealing member 50, the aforementioned sealing member 30 and the tubular body 40 are formed integrally with each other, so that the number of parts can be reduced, and a reduction in the number of assembly processes can be expected. It is to be understood, moreover, that the aforementioned effect of provision of the sealing member 30 can be obtained jointly with the effect of provision of the tubular body 40.

This invention is not limited directly to the embodiment described above, and in carrying out the invention, its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

What is claimed is:

1. A battery module comprising:
a cell which contains an electrode group and a non-aqueous electrolyte; and
a case including a cell containing portion which contains the cell and a hollow portion which communicates with the cell containing portion and configured so that an outlet is formed in each of a pair of sidewalls thereof which face each other with the hollow portion therebetween.

2. A battery module according to claim 1, which further comprises a sealing member which closely contacts the cell in the cell containing portion to seal the hollow portion to the cell containing portion.

3. A battery module according to claim 1, which further comprises a tubular body fitted in one of the pair of outlets.

4. A battery module according to claim 1, which further comprises a sealing member which closely contacts the cell in the cell containing portion to seal the hollow portion to the cell containing portion and includes a tubular body extending outward from one of the pair of outlets.

5. A battery pack comprising:
a battery module including a cell which contains an electrode group and a non-aqueous electrolyte and a case including a cell containing portion which contains the cell and a hollow portion which communicates with the cell containing portion and configured so that an outlet is formed in each of a pair of sidewalls thereof which face each other with the hollow portion therebetween; and
a tubular body fitted in the outlet formed in the case of the battery module,
a plurality of said battery modules being connected to one another by the tubular body.
